(19) United States
(12) Patent Application Publication
(10) Pub. No.: US 2017/0231353 A1
(43) Pub. Date: Aug. 17, 2017

(54) HAIR STYLING DEVICES AND METHODS OF USE

(71) Applicant: Gaetano Romeo, West Hollywood, CA (US)

(72) Inventor: Gaetano Romeo, West Hollywood, CA (US)

(21) Appl. No.: 15/430,329

(22) Filed: Feb. 10, 2017

Related U.S. Application Data
(60) Provisional application No. 62/294,378, filed on Feb. 12, 2016.

(51) Int. Cl. A45D 7/02; A45D 1/04; B26D 7/27; A45D 2/38

(52) U.S. Cl. CPC A45D 7/02; A45D 2/38; A45D 1/04; B26D 7/27

(57) ABSTRACT

Aspects of the present disclosure include a hair styling device. The device includes a grip portion contoured for being gripped by a user. The grip portion includes a power cable and a power switch at a first end for supplying and controlling electrical current to the hair styling device. The device also includes a heating portion configured to generate heat based on the electrical current. The heating portion extends from the grip portion at a second end, opposite the first end, and has a cross-sectional profile with side portions between substantially circular ends along a length of the heating portion. The heating portion is configured to apply the heat to hair wrapped around the heating portion to impart a wave in the hair according to the cross-sectional profile.

### CROSS-REFERENCE TO RELATED APPLICATIONS

This application claims the benefit of and priority to U.S. Provisional Application No. 62/294,378, filed Feb. 12, 2016, entitled, “HAIR STYLING DEVICES AND METHODS OF USE,” which is incorporated by reference herein in its entirety.

### TECHNICAL FIELD

The present disclosure relates to devices and methods for styling a naturally looking wave in hair. More particularly, the present disclosure relates to devices for styling a naturally looking wave in hair, along with methods used for shampooing, cutting, styling, and/or maintaining the naturally looking wave.

### BACKGROUND

Individuals often get their hair styled by a professional hairstylist. Such styling can include a shampoo, a haircut, and the styling itself, either alone or after the shampoo and/or haircut. Achieving and/or maintaining the same hair style days after visiting the professional hairstylist can be difficult, particularly if the style requires use of a hair styling device to achieve the desired style. For example, a typical individual lacks the skillset, hair styling devices, and knowledge and/or training of a professional hairstylist.

According to the foregoing issues, a need exists for hair styling devices that can be used at home to impart a particular style to an individual's hair, such as a naturally looking wave, along with associated methods of use.

### SUMMARY

Aspects of the present disclosure include a hair styling device. The device includes a grip portion contoured for being gripped by a user. The grip portion includes a power cable and a power switch at a first end for supplying and controlling electrical current to the hair styling device. The device also includes a heating portion configured to generate heat based on the electrical current. The heating portion extends from the grip portion at a second end, opposite the first end, and has a cross-sectional profile with curved side portions between substantially circular ends along a length of the heating portion. The heating portion is configured to apply the heat to hair wrapped around the heating portion to impart a wave in the hair according to the cross-sectional profile.

Aspects of the present disclosure further include a method of styling hair. The method includes sectioning off the hair into at least three horizontal sections, the three horizontal sections including a first section forming a horse shoe part at the crown of the head, a second section from the top of the ears and ending at the occipital bone, and a third section ending at the nape. However, the number of sections and subsections described throughout can vary depending on the density of the hair, the thickness of the hair, or both. The method further includes sectioning off each of the at least three horizontal sections into subsections, each of the subsections being sized so as to be styled with the hair styling device. The method also includes wrapping each of the subsections around a heating portion, and rotating the heating portion as each of the subsections are drawn across the heating portion to impart the cross-sectional profile of the heating portion in the subsections.

A further aspect of the present disclosure is a method of cutting hair on a head of an individual. The method includes sectioning off the hair into at least three horizontal sections, the three horizontal sections including a first section forming a horse shoe part at the crown of the head, a second section ending at the ears across the occipital bone, and a third section ending at the nape. The method further includes sectioning off each of the at least three horizontal sections into subsections, each of the subsections being sized so as to be cut with scissors with a single cut. The method also includes combing and twisting each of the subsections of the hair as each of the subsections of the hair is lifted vertically to be substantially straight up into the air, and cutting the ends of the hair according to a taper cut with the hair approximately straight up in the air.

These and other capabilities of the disclosed devices and methods will be more fully understood after a review of the following figures, detailed description, and claims.

### BRIEF DESCRIPTION OF THE DRAWINGS

FIG. 1A shows a perspective view of a hair styling device, in accord with aspects of the present disclosure;

FIG. 1B shows a view of the distal end of the hair styling device of FIG. 1A, in accord with aspects of the present disclosure;

FIG. 2A shows a perspective view of another hair styling device, in accord with aspects of the present disclosure;

FIG. 2B shows a perspective view of the heating portion of the hair styling device of FIG. 2A, in accord with aspects of the present disclosure;

FIG. 3A shows a perspective view of another hair styling device, in accord with aspects of the present disclosure;

FIG. 3B shows a view of the distal end of the hair styling device of FIG. 3A, in accord with aspects of the present disclosure;

FIG. 3C shows a perspective view of the heating portion of the hair styling device of FIG. 3A, in accord with aspects of the present disclosure;

FIG. 4A shows a perspective view of another hair styling device, in accord with aspects of the present disclosure;

FIG. 4B shows a view of the distal end of the hair styling device of FIG. 4A, in accord with aspects of the present disclosure;

FIG. 4C shows a view of the top of the hair styling device of FIG. 4A, in accord with aspects of the present disclosure;

FIG. 4D shows a view of the side of the hair styling device of FIG. 4A, in accord with aspects of the present disclosure;

FIG. 4E shows a view of the hair styling device of FIG. 4A in cross section according to the line 4E-4E in FIG. 4C, in accord with aspects of the present disclosure;

FIG. 5 shows a flow diagram of a method of cutting hair, prior to styling the hair using a hair styling device as described herein, in accord with aspects of the present disclosure;

FIG. 6 shows a section of hair being trimmed with scissors, in accord with aspects of the present disclosure;

FIG. 7 shows a perspective view of a head of hair 700 sectioned off as described below, in accord with aspects of the present disclosure;

FIG. 8 shows a flow diagram of a method of styling hair using a hair styling device as described herein, in accord with aspects of the present disclosure; and

FIG. 9 shows a flow diagram of a method of maintaining hair after styling the hair using a hair styling device as described herein, in accord with aspects of the present disclosure.

While the apparatuses and methods discussed herein are susceptible to various modifications and alternative forms, specific embodiments have been shown by way of example in the drawings and will be described in detail herein. It should be understood, however, that the description is not intended to be limited to the particular forms disclosed. Rather, the description is to cover all modifications, equivalents, and alternatives falling within the spirit and scope of the present disclosure as defined by the appended claims.

### DETAILED DESCRIPTION

While the apparatuses discussed in the present disclosure are susceptible of embodiment in many different forms, there is shown in the drawings and will herein be described in detail preferred embodiments of the apparatuses with the understanding that the present disclosure is to be considered as an exemplification of the principles of the apparatuses and is not intended to limit the broad aspect of the apparatuses to the embodiments illustrated. For purposes of the present detailed description, the singular includes the plural and vice versa (unless specifically disclaimed); the word “or” shall be both conjunctive and disjunctive; the word “all” means “any and all”; the word “any” means “any and all”; and the word “including” means “including without limitation.” Additionally, the singular terms “a,” “an,” and “the” include plural referents unless context clearly indicates otherwise.

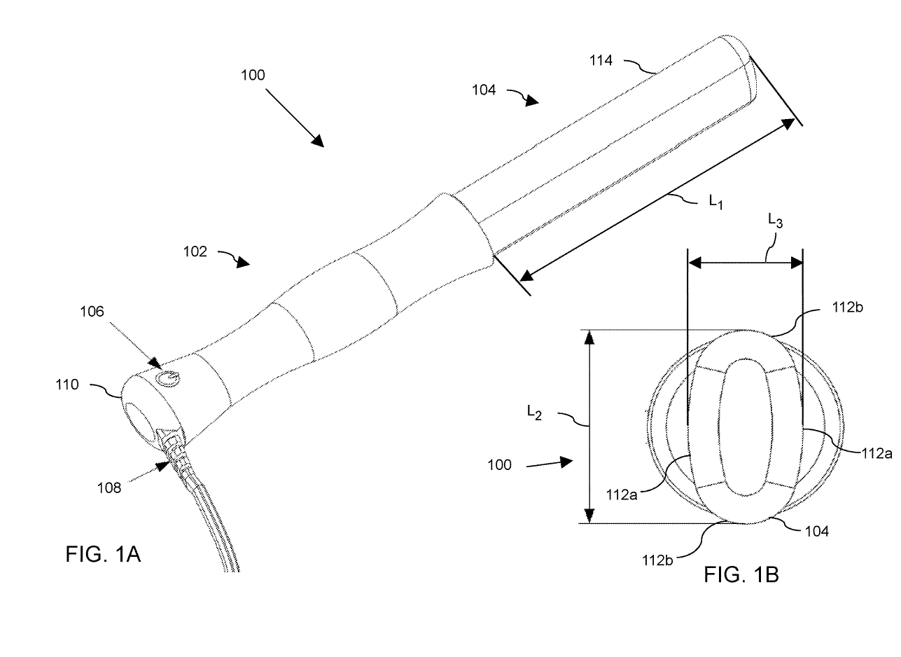

FIGS. 1A and 1B show a hair styling device 100, in accord with aspects of the present disclosure. The hair styling device 100 includes a grip portion 102 and a heating portion 104. According to the hair styling device 100, the grip portion 102 and the heating portion 104 are fixed such that the heating portion 104 cannot rotate relative to the grip portion 102 about the longitudinal axis of the hair styling device 100.

The grip portion 102 has an ergonomic contour that allows for gripping by a user (e.g., professional hairstylist, non-professional individual, etc.) during use of the hair styling device 100. The grip portion 102 can be formed of any suitable material(s) that allows a user to grip the grip portion 102 while preventing or reducing the conduction of heat from the heating portion 104 to the user. According to some embodiments, the grip portion 102 is formed of a heat-resistant and/or insulated plastic or metal. However, the grip portion 102 can be formed of various other materials without departing from the spirit and scope of the present disclosure.

On the opposite end from the heating portion 104, the grip portion 102 includes a power switch 106 and a power cable 108. The power switch 106 controls the ON/OFF state of the heating portion 104 by controlling the flow of electrical current from the power cable 108. At one end, the power cable 108 includes a plug (not shown) that connects to a power outlet for supplying the electrical current to the hair styling device 100. At the opposite end, the power cable 108 connects to the grip portion 102. The grip portion 102 includes a rotary connector 110 that allows the power cable 108 to rotate axially about the end of the grip portion 102. The rotary connector 110 allows a user to manipulate the hair styling device 100 to impart a stylized wave in hair, as further described below, while reducing or eliminating interference by the power cable 108 during use. However, according to some embodiments, the power cable 108 can instead be coupled to the grip portion 102 such that the power cable 108 cannot rotate about the end of the grip portion 102.

Referring to FIG. 1B, the heating portion 104 has an oval-like cross-sectional profile. More specifically, the cross-sectional profile of the heating portion 104 includes slightly curved portions 112a between substantially circular (e.g., half circles) ends 112b. Thus, the cross-sectional profile is described herein as oval-like, rather than merely oval, based on the circular ends 112b having a substantially constant radius of curvature between the slightly curved portions 112a. In contrast, an oval or elliptical cross-sectional profile has a decreasing radius of curvature towards the long axis of the oval and/or ellipse. The substantially circular shape of the circular ends 112b provides for a more consistent and uniform transfer of heat to hair from the heating portion 104 as compared to, for example, a heating wand with an oval or elliptical cross-sectional profile. Specifically, and without being limited by theory, it is believed that the smaller radius of curvature at the long axis of heating wands with an oval or elliptical cross-sectional profile may apply a tighter curl to the hair based on the strain the smaller radius of curvature places on the hair wrapped around the heating wand and the resulting increased heat transfer. In contrast, the substantially circular ends 112b of the heating portion 104, with the greater and substantially constant radius of curvature, reduce the amount of curl applied to the hair, providing a more natural curl and look to the hair. Moreover, the oval-like cross-sectional profile allows a user to impart a naturally looking wave in hair based on the slightly curved portions 112a and the substantially circular ends 112b. Application of such a naturally looking wave is further aided in combination with the methods of styling the hair, as further discussed below. Thus, based on the oval-like cross-sectional profile rather than, for example, a circular, oval, or elliptical cross-sectional profile, the heating portion 104 imparts a more naturally looking wave in the hair.

The heating portion 104 includes a resistive heating element (not shown) that generates heat based on the application of the electrical current supplied by the power cable 108. The heat generated by the resistive heating element is transferred to a heat conducting portion 114. The heat conducting portion 114 is, in part, the external surface of the heating portion 104. The heat conducting portion 114 can be formed of various heat conducting materials. According to one embodiment, the heat conducting portion 114 is gold plated to provide for both improved heat transfer to a user's hair and corrosion resistance. However, the heat conducting portion 114 can be formed of various other materials without departing from the spirit and scope of the present disclosure.

The dimensions of the heating portion 104 can vary depending on the overall size of the hair styling device 100. The overall length L₁ of the heating portion 104 can be about 6 to 10 inches, such as about 8 inches. The length L₂ of the long axis of the oval-like cross-sectional profile of the heating portion 104 can be about 1.25 to 1.75 inches, such as about 1.25 inches for a small hair styling device 100, about 1.50 inches for a medium hair styling device 100, and about 1.75 inches for a large hair styling device 100. The length L₃ of the small axis of the oval cross-sectional profile of the heating portion 104 can be about ¾ to 1 inch, such as about ¾ of an inch for a small hair styling device 100, about ⅞ of an inch for a medium hair styling device 100, and about 1 inch for a large hair styling device 100.

Based on the hair styling device 100, alone and in combination with the methods discussed below, a user can style a naturally looking wave in his or her hair based, at least in part, on the oval-like cross-sectional profile of the heating portion 104 and based on rotating the heating portion 104 when wrapped with the user's hair. Again, based on the oval-like cross-sectional profile rather than, for example, a circular cross-sectional profile, the heating portion 104 imparts a more naturally looking and/or varying wave in the hair.

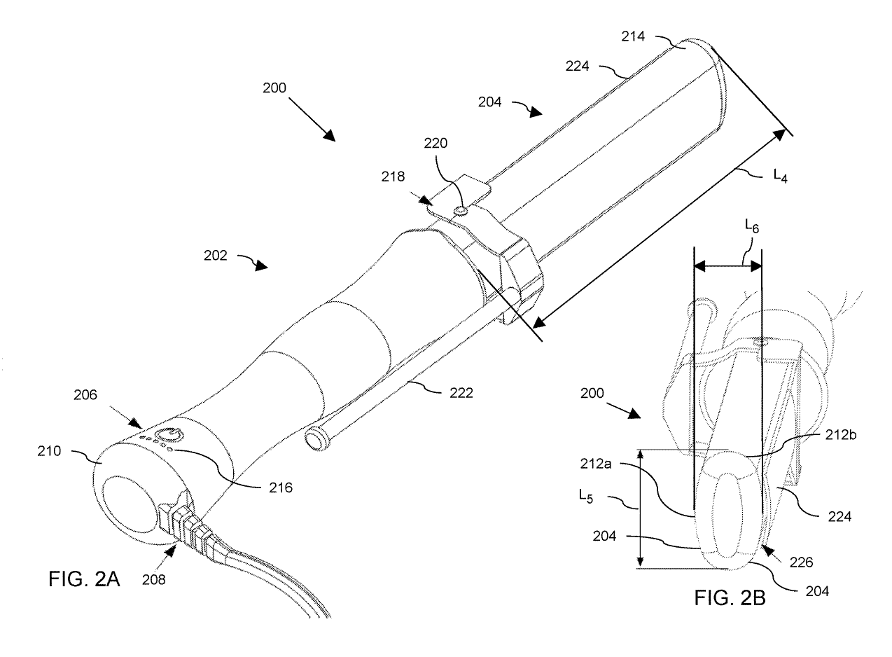

FIGS. 2A and 2B show a hair styling device 200 in accord with additional aspects of the present concepts. The hair styling device 200 includes a grip portion 202 and a heating portion 204. The grip portion 202 has an ergonomic contour that allows for gripping by a user (e.g., professional hairstylist, non-professional individual, etc.) during use of the hair styling device 200. The grip portion 202 can be formed of any suitable material that allows a user to grip the grip portion 202 while preventing or reducing the conduction of heat from the heating portion 204 to the user. According to some embodiments, the grip portion 202 is formed of a heat-resistant and/or insulated plastic or metal. However, the grip portion 202 can be formed of various other materials without departing from the spirit and scope of the present disclosure.

The interface between the grip portion 202 and the heating portion 204 may be fixed such that the heating portion 204 cannot move (e.g., rotate) relative to the grip portion 202. Alternatively, the interface between the grip portion 202 and the heating portion 204 may allow for the heating portion 204 to rotate freely relative to the grip portion 202 about the longitudinal axis of the hair styling device 200.

On the opposite end from the heating portion 204, the grip portion 202 includes a power switch 206 and a power cable 208. The power switch 206 controls the ON/OFF state of the heating portion 204 by controlling the flow of electrical current from the power cable 208. In addition, the power switch 206 controls the amount of heat provided by the heating portion 204. For example, initially selecting the power switch 206 turns on the hair styling device 200 at its lowest or highest heating level. Repeatedly selecting the power switch 206 increases or decreases the amount of heat generated by the hair styling device 200. The greater the amount of heat generated, the faster and/or more pronounced the styling is imparted by the hair styling device 200. As shown, the grip portion 202 can include a power level indicator 216 that includes, for example, a series of lights that indicate the power level and, correspondingly, the amount of heat generated. For example, the greater the number of lights that are lit up, the greater the power level and the amount of heat provided. However, the power level indicator 216 can indicate the power level according to any one or more indicia and/or schema, including visual, auditory, and tactile indications. For example, the power level indicator 216 can instead display numbers that correspond to the power level.

The power cable 208 includes a plug at one end (not shown) that connects to a power outlet for supplying electrical current to the hair styling device 200. At the opposite end, the power cable 208 connects to the grip portion 202. The grip portion 202 includes a rotary connector 210 that allows the power cable 208 to rotate axially about the end of the grip portion 202. The rotary connector 210 allows a user to manipulate the hair styling device 200 to impart the naturally looking wave, as further described below, while reducing or eliminating interference by the power cable 208 during manipulation. However, according to some embodiments, the power cable 208 can instead be coupled to the grip portion 202 such that the power cable 208 cannot rotate about the end of the grip portion 202.

Referring to FIG. 2B, the heating portion 204 has a generally oval-like cross-sectional profile. More specifically, the cross-sectional profile of the heating portion 204 includes slightly curved portions 212a between substantially circular (e.g., half circles) ends 212b. Thus, as described above, the cross-sectional profile is oval-like, rather than merely oval, based on the circular ends 212b having a substantially constant radius of curvature between the slightly curved portions 212a. In contrast, an oval or elliptical cross-sectional profile has a decreasing radius of curvature towards the long axis of the oval and/or ellipse. The substantially circular shape of the circular ends 212b provides for a more consistent and uniform transfer of heat to hair from the heating portion 204 as compared to, for example, a heating wand with an oval or elliptical cross-sectional profile. Specifically, and without being limited by theory, it is believed that the smaller radius of curvature at the long axis of heating wands with an oval or elliptical cross-sectional profile may apply a tighter curl to the hair based on the strain the smaller radius of curvature places on the hair wrapped around the heating wand and the resulting increased heat transfer coefficient. In contrast, the substantially circular ends 212b of the heating portion 204, with the greater and substantially constant radius of curvature, reduce the amount of curl applied to the hair, providing a more natural curl and look to the hair. Moreover, the oval-like cross-sectional profile allows a user to impart a naturally looking wave in hair based on the slightly curved portions 212a and the substantially circular ends 212b. Application of such a naturally looking wave is further aided in combination with the methods of styling the hair, as further discussed below. Thus, based on the oval-like cross-sectional profile rather than, for example, a circular, oval, or elliptical cross-sectional profile, the heating portion 204 imparts a more naturally looking wave in the hair.

The heating portion 204 includes a resistive heating element (not shown) that generates heat based on the application of electrical current supplied by the power cable 208. The heat generated by the resistive heating element is transferred to a heat conducting portion 214. The heat conducting portion 214 is, in part, the external surface of the heating portion 204. The heat conducting portion 214 can be formed of various heat conducting materials. According to one embodiment, the heat conducting portion 214 is gold plated to provide for both improved heat transfer to a user's hair and corrosion resistance. However, the heat conducting portion 214 can be formed of various other materials without departing from the spirit and scope of the present disclosure.

The dimensions of the heating portion 204 can vary depending on the overall size of the hair styling device 200. The overall length L₄ of the heating portion 204 can be about 6 to 10 inches, such as about 8 inches. The length L₅ of the long axis of the oval-like cross-sectional profile of the heating portion 204 can be about 1.25 to 1.75 inches, such as about 1.25 inches for a small hair styling device 200, about 1.50 inches for a medium hair styling device 200, and about 1.75 inches for a large hair styling device 200. The length L₆ of the small axis of the oval-like cross-sectional profile of the heating portion 204 can be about ¾ to 1 inch, such as about ¾ of an inch for a small hair styling device 200, about ⅞ of an inch for a medium hair styling device 200, and about 1 inch for a large-sized hair styling device 200.

The hair styling device 200 also includes a tang assembly 218. The tang assembly 218 attaches to the heating portion 204 at a pivot point 220. The tang assembly 218 includes a handle 222 and a tang 224. The handle 222 is adjacent to and extends down a length of the grip portion 202. The handle 222 allows a user gripping the grip portion 202 to manipulate the tang 224 between an open position and a closed position (FIG. 2B) while using the hair styling device 200. The tang 224 extends down substantially the entire length of the heating portion 204 such that the length of the tang 224 is substantially the same as the length of the heating portion 204. As shown in FIG. 2B, the width of the tang 224 corresponds to substantially the width of the slightly curved portions 212a of the cross-sectional profile of the heating portion 204. Further, the curvature of the tang 224 matches the curvature of the slightly curved portions 212a of the heating portion 204 adjacent the tang 224.

In the closed position, as shown in FIGS. 2A and 2B, the tang assembly 218 is configured to leave a gap 226 between the heating portion 204 and the tang 224. The gap 226 limits, in part, the transfer of heat from the heating portion 204 to the user's hair to aid the user in imparting the wave in the user's hair, in combination with the below-described methods, while allowing the hair to move smoothly between the tang 224 and the heating portion 204. According to some embodiments, the gap 226 is about 1 to 5 millimeters (mm), such as about 2 mm.

The tang 224 allows a user (e.g., professional hairstylist, non-professional individual, etc.) to hold hair between the heating portion 204 and the tang 224, and then repeatedly wrap the hair around the heating portion 204 and the tang 224. Alternatively, the user can hold the hair between the heating portion 204 and the tang 224 and then rotate the heating portion 204 while drawing the hair smoothly through the gap 226. The thickness and profile of the tang 224 allows for the transfer of heat to hair wrapped around the heating portion 204 and tang 224 while not substantially affecting the overall oval-like cross-sectional profile of the tang 224. By way of example, and without limitation, the thickness of the tang 224 is about 0.5 to 2 mm, such as about 1 mm.

Based on the hair styling device 200, and in combination with the methods discussed below, a user can style a naturally looking wave in his or her hair based, at least in part, on the oval-like cross-sectional profile of the heating portion 204 and based on rotating the heating portion 204 with hair wrapped around the heating portion 204. Again, based on the oval-like cross-sectional profile rather than, for example, a circular cross-sectional profile, the heating portion 204 imparts a more naturally looking and/or varying wave in the hair.

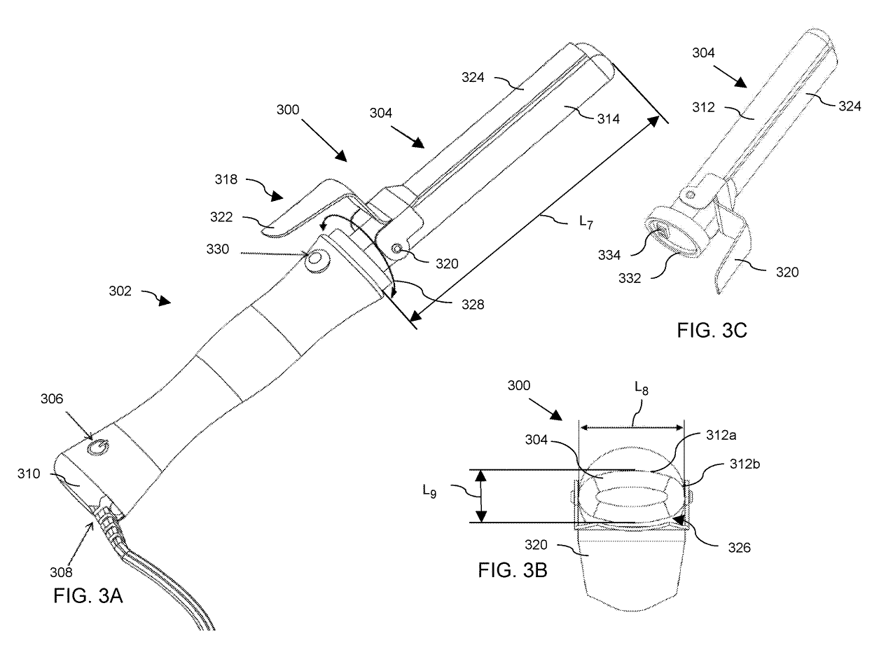

FIGS. 3A-3C show an additional hair styling device 300 in accord with aspects of the present concepts. The hair styling device 300 includes a grip portion 302 and a heating portion 304. The grip portion 302 has an ergonomic contour that allows for gripping by a user during use of the hair styling device 300. The grip portion 302 can be formed of any suitable material(s) that allows a user to grip the grip portion 302 while preventing or reducing the conduction of heat from the heating portion 304 to the user. According to some embodiments, the grip portion 302 is formed of a heat-resistant and/or insulated plastic or metal. However, the grip portion 302 can be formed of various other materials without departing from the spirit and scope of the present concepts.

The grip portion 302 includes a power switch 306 and a power cable 308 on the opposite end from the heating portion 304. The power switch 306 controls the ON/OFF state of the heating portion 304 by controlling the flow of electrical current from the power cable 308. Although not shown in FIGS. 3A-3C, the grip portion 302 can include a power level indicator that indicates the power level and, correspondingly, the amount of heat generated by the heating portion 304.

The power cable 308 includes a plug at one end (not shown) that connects to a power outlet for supplying electrical current to the hair styling device 300. At the opposite end, the power cable 308 connects to the grip portion 302. The grip portion 302 includes a rotary connector 310 that allows the power cable 308 to rotate axially about the end of the grip portion 302. However, according to some embodiments, the power cable 308 can instead be coupled to the grip portion 302 such that the power cable 308 cannot rotate about the end of the grip portion 302.

The interface between the grip portion 302 and the heating portion 304 may be fixed such that the heating portion 304 cannot move (e.g., axially rotate) relative to the grip portion 302. Alternatively, and as shown by arrow 328 in FIG. 3A, the interface between the grip portion 302 and the heating portion 304 may allow for the heating portion 304 to rotate relative to the grip portion 302 about the longitudinal axis of the hair styling device 300.

Further, according to some embodiments, the grip portion 302 includes a motor that operates to cause the heating portion 304 to rotate relative to the grip portion 302 about the longitudinal axis of the hair styling device 300. To control the operation of the motor, the grip portion includes a button 330 that controls the ON/OFF state of the motor. According to some embodiments, the button 330 further controls the rotational direction of the heating portion 304 relative to the grip portion 302 to allow a user to rotate the heating portion 304 clockwise or counterclockwise, depending on the desired direction of the rotation. Alternatively, or in addition, according to some embodiments, the grip portion 302 includes a sensor (not shown) that determines the intended rotational direction of the heating portion 304 relative to the grip portion 302 based on movement of the hair styling device 300 by the user. By way of example, and without limitation, if the user rotates the grip portion in one direction (e.g., clockwise), the sensor detects the rotation and activates the motor to rotate the heating portion 304 in the same direction. The sensor can be one or more electrical, mechanical-electrical, and/or mechanical sensors that determine the intended rotational direction. By way of example, and without limitation, the sensor within the grip portion 302 can be one or more of a gyroscope, an accelerometer, and the like, or a combination thereof. Operation of the motor in rotating the heating portion 304 aids the user in applying a rotational action to the hair to help impart a naturally looking wave in the hair, particularly in combination with the below-described methods for styling hair.

Referring to FIG. 3B, the heating portion 304 has a generally oval-like cross-sectional profile. More specifically, the cross-sectional profile of the heating portion 304 includes slightly curved portions 312a between substantially circular (e.g., half circles) ends 312b. Thus, the cross-sectional profile is described herein as oval-like, rather than merely oval, based on the circular ends 312b having a substantially constant radius of curvature between the slightly curved portions 312a. In contrast, an oval or elliptical cross-sectional profile has a decreasing radius of curvature towards the long axis of the oval and/or ellipse. The substantially circular shape of the circular ends 312b provides for a more consistent and uniform transfer of heat to hair from the heating portion 304 as compared to, for example, a heating wand with an oval or elliptical cross-sectional profile. Specifically, and without being limited by theory, it is believed that the smaller radius of curvature at the long axis of heating wands with an oval or elliptical cross-sectional profile may apply a tighter curl to the hair based on the strain the smaller radius of curvature places on the hair wrapped around the heating wand and the resulting increased heat transfer coefficient. In contrast, the substantially circular ends 312b of the heating portion 304, with the greater and substantially constant radius of curvature, reduce the amount of curl applied to the hair, providing a more natural curl and look to the hair. Moreover, the oval-like cross-sectional profile allows a user to impart a naturally looking wave in hair based on the slightly curved portions 312a and the substantially circular ends 312b. Application of such a naturally looking wave is further aided in combination with the methods of styling the hair, as further discussed below. Thus, based on the oval-like cross-sectional profile rather than, for example, a circular, oval, or elliptical cross-sectional profile, the heating portion 304 imparts a more naturally looking wave in the hair.

The heating portion 304 includes a resistive heating element (not shown) that generates heat based on the application of electrical current supplied by the power cable 308. The heat generated by the resistive heating element is transferred to a heat conducting portion 314 that is, in part, the external surface of the heating portion 304. The heat conducting portion 314 can be formed of various heat conducting materials. According to one embodiment, the heat conducting portion 314 is gold plated to provide for both heat transfer to a user's hair and corrosion resistance. However, the heat conducting portion 314 can be formed of various other materials without departing from the spirit and scope of the present disclosure.

The dimensions of the heating portion 304 can vary depending on the overall desired size of the hair styling device 300. The overall length L₇ of the heating portion 304 can be about 6 to 10 inches, such as about 8 inches. The length L₈ of the long axis of the oval-like cross-sectional profile of the heating portion 304 can be about 1.25 to 1.75 inches, such as about 1.25 inches for a small hair styling device 300, about 1.50 inches for a medium hair styling device 300, and about 1.75 inches for a large hair styling device 300. The length L₉ of the small axis of the oval-like cross-sectional profile of the heating portion 304 can be about ¾ to 1 inch, such as about ¾ of an inch for a small hair styling device 300, about ⅞ of an inch for a medium hair styling device 300, and about 1 inch for a large hair styling device 300.

The hair styling device 300 also includes a tang assembly 318. The tang assembly 318 attaches to the heating portion 304 at a pivot point 320. The tang assembly 318 includes a handle 322 and a tang 324. The handle 322 is raised and extends above the button 330 down a length of the grip portion 302. The handle 322 allows a user gripping the grip portion 302 to manipulate the tang 324 between an open position and a closed position (FIGS. 3A-3C) while using the hair styling device 300. Based on the placement of the button 330, and so as to not interfere with a user gripping the grip portion 302 during rotation of the heating portion 304, the handle 322 is raised to clear, for example, the user's thumb or finger operating the button 330.

In the closed position, as shown in FIGS. 3A-3C, the tang assembly 318 is configured to leave a gap 326 between the heating portion 304 and the tang 324. The gap 326 limits the tension on the user's hair to aid the user in imparting the wave in the user's hair, in combination with the below-described methods, while allowing the hair to move loosely between the heating portion 304 and the tang 324. According to some embodiments, the gap 326 is about 1 to 5 mm, such as about 2 mm.

The tang 324 allows a user (e.g., professional hairstylist, non-professional individual, etc.) to hold hair between the heating portion 304 and the tang 324, and then repeatedly wrap the hair around the heating portion 304 and the tang 324. Alternatively, the user can hold the hair between the heating portion 304 and the tang 324 and then rotate the heating portion 304 while drawing the hair through the gap 326. The thickness and profile of the tang 324 allows for the transfer of heat to hair wrapped around the heating portion 304 and tang 324 while not substantially affecting the overall oval-like cross-sectional profile of the tang 324. By way of example, and without limitation, the thickness of the tang 324 is about 0.5 to 2 mm, such as about 1 mm.

For the hair styling device 300, the heating portion 304 can detach from the grip portion 302. FIG. 3C shows the heating portion 304 detached from the grip portion 302. The heating portion 304 can detach from the grip portion to, for example, allow for different sizes of heating portions 304 to attach to the same grip portion 302. According to this arrangement, the heating portion 304 includes a mechanical couple 332, such as an O-ring, that allows the heating portion 304 to attach and detach from the grip portion 302. The heating portion 304 also includes a connector 334 that connects to a corresponding connector (not shown) on the grip portion 302 to electrically couple the heating portion 304 to the grip portion 302 to provide the electrical current to the heating element.

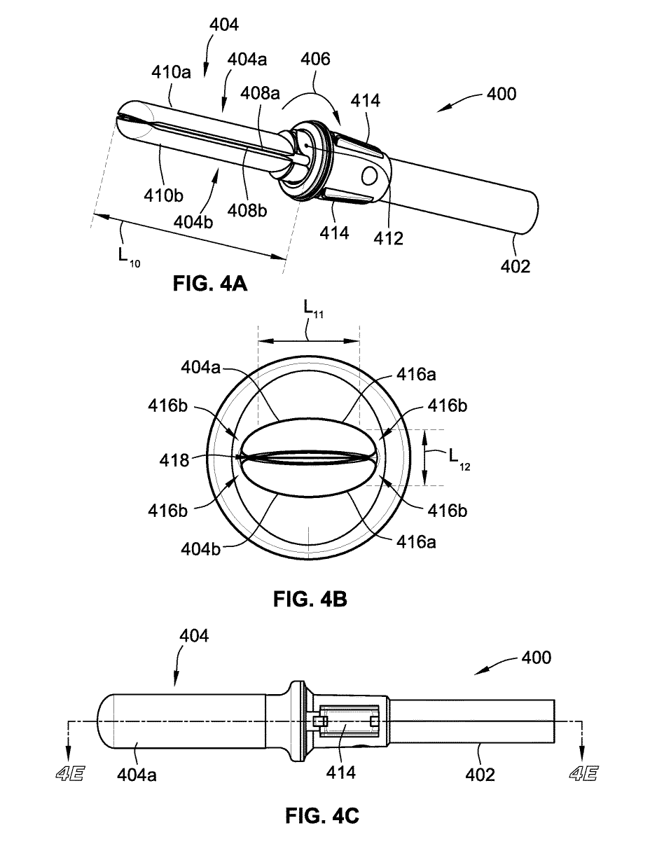

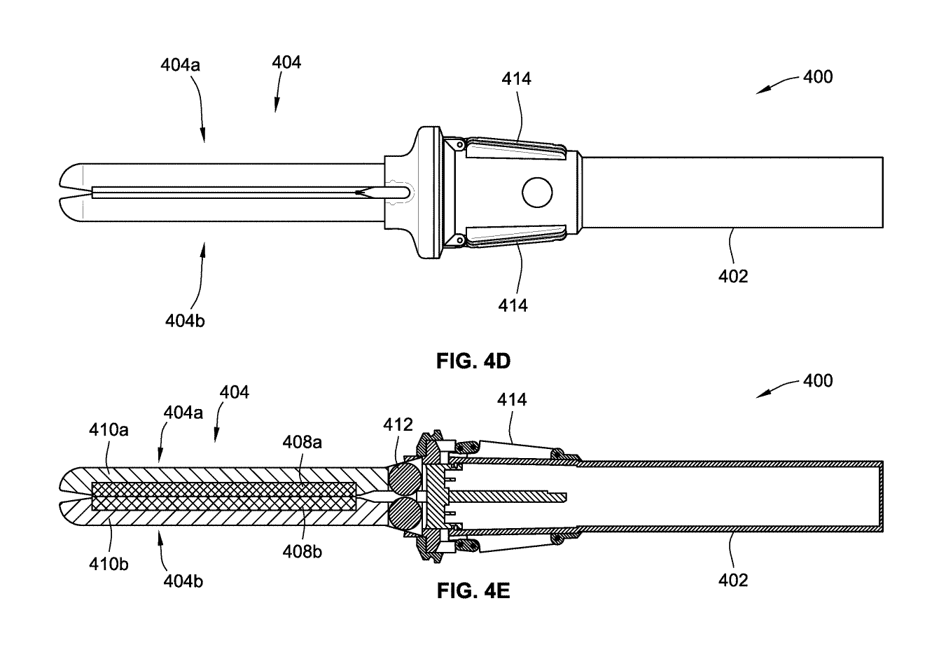

FIGS. 4A-4E show an additional hair styling device 400 in accord with aspects of the present concepts. The hair styling device 400 includes a grip portion 402 and a heating portion 404. The grip portion 402 can have an ergonomic contour that allows for gripping by a user during use of the hair styling device 400. The grip portion 402 can be formed of any suitable material(s) that allows a user to grip the grip portion 402 while preventing or reducing the conduction of heat from the heating portion 404 to the user. According to some embodiments, the grip portion 402 is formed of a heat-resistant and/or insulated plastic or metal. However, the grip portion 402 can be formed of various other materials without departing from the spirit and scope of the present concepts.

The interface between the grip portion 402 and the heating portion 404 can be fixed such that the heating portion 404 cannot move (e.g., rotate) relative to the grip portion 402. Alternatively, and as shown by arrow 406 in FIG. 4A, the interface between the grip portion 402 and the heating portion 404 can allow for the heating portion 404 to rotate relative to the grip portion 402 about the longitudinal axis of the hair styling device 400.

The heating portion 404 includes two blades 404a and 404b. The inner portion of each blade 404a, 404b is a heating element 408a, 408b. Each heating element 408a, 408b is a resistive heating element that generates heat based on the application of electrical current supplied by a power cable (not shown). The heat generated by the resistive heating elements 408a and 408b is transferred to heat conducting portions 410a and 410b that form the exterior facing surface of the heating portion 404. The heat conducting portions 410a and 410b can be formed of various heat conducting materials. According to one embodiment, the heat conducting portions 410a and 410b are gold plated to provide for both heat transfer to a user's hair and corrosion resistance. However, the heat conducting portions 410a and 410b can be formed of various other materials without departing from the spirit and scope of the present disclosure, such as other metals and/or alloys (e.g., silver, copper, aluminum, etc.) un-coated or coated with one or more materials (e.g., ceramics). The heating elements 408a and 408b can be configured to reach temperatures of about 450° F. at the hair, with the resistive elements within reaching temperatures of about 600 to 650° F.

The heating elements 408a and 408b can have various shapes and sizes. In some aspects, the heating elements 408a and 408b can be rectangular with a width of about 35 mm, a length of about 120 mm, and a thickness of about 1.7 mm. However, the shape and size can vary without departing from the spirit and scope of the present disclosure.

The two blades 404a and 404b can be configured to separate and retract to allow hair to be placed there between. In some aspects, both of the blades 404a and 404b can be configured to separate and retract. Alternatively, only one of the blades 404a and 404b can be configured to separate and retract. As illustrated in FIGS. 4A and 4B, the blade 404a can include a hinge 412 about which the blade 404a rotates to move relative to the blade 404b, which can be configured to be fixed.

The grip portion 404 can include buttons 414 that a user can depress to cause the blade 404a to rotate about the hinge 412 to separate the blade 404a from the blade 404b, such as to allow hair to be placed between the blades 404a and 404b. The blades 404a and 404b can be configured to apply a desired amount of force to the hair gripped there between. In some aspects, the blades 404a and 404b can be configured to apply up to 10 lbs of force to the hair. The blades 404a and 404b can be connected to one or more springs to provide the compressive force. The amount of force applied can be dependent on whether the user is applying any force to separate the blades 404a and 404b, such as to counteract the default compressive force applied by the blades 404a and 404b. In some aspects, the hair styling device 400 can include a stop that allows a user to configure the blades 404a and 404b to apply a set amount of force to the hair, such as a force between 0 to 10 lbs. In some aspects, the upper limit of the range can be less than or greater than 10 lbs of force depending on, for example, the intended user of the device (e.g., professional hairstylist, non-professional individual, etc.). The compression of the blades 404a and 404b on the hair can depend or be set based on the user's feel of pressure and the desired styling result of the hair.

Referring to FIG. 4B, the combination of the blades 404a and 404b of the heating portion 404 form a generally oval-like cross-sectional profile. More specifically, the cross-sectional profile of the heating portion 404 includes slightly curved portions 416a between substantially circular (e.g., quarter circles) ends 416b, with the blades 404a and 404b together in a closed position. Thus, the entire cross-sectional profile is described herein as oval-like, rather than merely oval, based on the pairs of circular ends 416b having a substantially constant radius of curvature between the slightly curved portions 416a. In contrast, an oval or elliptical cross-sectional profile has a decreasing radius of curvature towards the long axis of the oval and/or ellipse. The substantially circular shape of the circular ends 416b provides for a more consistent and uniform transfer of heat to hair from the heating portion 404 as compared to, for example, a heating wand with an oval or elliptical cross-sectional profile. Specifically, and without being limited by theory, it is believed that the smaller radius of curvature at the long axis of heating wands with an oval or elliptical cross-sectional profile may apply a tighter curl to the hair based on the strain the smaller radius of curvature places on the hair wrapped around the heating portion 404 and the resulting increased heat transfer coefficient. In contrast, the substantially circular ends 416b of the heating portion 404, with the greater and substantially constant radius of curvature, reduce the amount of curl applied to the hair, providing a more natural curl and look to the hair. Moreover, the oval-like cross-sectional profile allows a user to impart a naturally looking wave in hair based on the slightly curved portions 416a and the substantially circular ends 416b. Application of such a naturally looking wave is further aided in combination with the methods of styling the hair, as further discussed below. Thus, based on the oval-like cross-sectional profile rather than, for example, a circular, oval, or elliptical cross-sectional profile, the heating portion 404 imparts a more naturally looking wave in the hair.

The dimensions of the heating portion 404 can vary depending on the overall desired size of the hair styling device 400. The overall length L₁₀ of the heating portion 404 can be about 6 to 10 inches, such as about 8 inches. The length L₁₁ of the long axis of the oval-like cross-sectional profile of the heating portion 404 can be about 1.25 to 1.75 inches, such as about 1.25 inches for a small hair styling device 400, about 1.50 inches for a medium hair styling device 400, and about 1.75 inches for a large hair styling device 400. The length L₁₂ of the small axis of the oval-like cross-sectional profile of the heating portion 404 can be about ¾ to 1 inch, such as about ¾ of an inch for a small hair styling device 400, about ⅞ of an inch for a medium hair styling device 400, and about 1 inch for a large hair styling device 400.

In the closed position, as shown in FIGS. 4A-4E, the heating portion 404 is configured to leave a gap 418 between the heating elements 414a and 414b. The gap 418 limits the tension on the user's hair to aid the user in imparting the wave in the user's hair, in combination with the below-described methods, while allowing the hair to move loosely between the heating elements 414a and 414b. According to some embodiments, the gap 418 is about 1 to 5 mm, such as about 2 mm.

The blades 414a and 414b allow a user (e.g., professional hairstylist, non-professional individual, etc.) to hold hair between the heating elements 408a and 408b, and then repeatedly wrap the hair around the heating portion 404. Alternatively, the user can hold the hair between the heating elements 408a and 408b and then rotate the heating elements 408a and 408b while drawing the hair through the gap 418.

As discussed above, the hair styling device 400 can be configured so that the heating portion 404 can rotate relative to the grip portion 402 about the longitudinal axis of the hair styling device 400. The grip portion 402 can include a motor (not shown) that powers the rotation of the heating portion 404. Hair can be gripped between the blades 404a and 404b while a user activates the motor to wrap the hair around the heating portion 404. Activation of the motor can also allow the user to apply a desired amount of tension to the hair while it is wrapped around the heating portion 404. In some aspects, the hair styling device 400 can include a gearbox (not shown) that connects the motor to the heating portion 404. The motor, gearbox, or a combination of both can be configured to limit the amount of tension applied to the hair to be within the range of about 0 to 10 lbs of force. For example, if an amount of force applied to the hair exceeds this range, such as by the motor pulling too hard or the user pulling the hair away from the hair styling device 400 too much, the gearbox can be configured to slip. In some aspects, the upper limit of the range can be less than or greater than 10 lbs of force depending on, for example, the intended user of the device (e.g., professional hairstylist, non-professional individual, etc.). In some aspects, the hair styling device 400 can include a control portion (e.g., knob, switch, lever, etc.) that allows the user to adjust the upper limit of the range of force applied by the motor.

The speed of rotation of the blades 404a and 404b caused by the motor can, in some aspects, be about 0 to 150 rotations per minute (rpm) or about 0 to 100 rpm. In some aspects, the speed can be fixed, such as fixed at 100 rpm or 50 rpm. In alternative aspects, the speed can be variable and set by the user, such as with a control portion (e.g., knob, switch, lever, etc.). For example, the user can set the rotation speed to a value between 0 to 100 rpm depending on the desired speed that the hair is to be wrapped around the heating portion 404. The rotational speed can be set to allow the user to reach the desired effect/style.

The hair styling devices 100-400 of FIGS. 1A-4E can be used to impart a particular style to hair, including the naturally looking wave described above. Methods are described below for achieving a particular naturally looking wave in hair. However, the hair styling devices 100-400 described above can be used to achieve various styles than what is limited to those described herein.

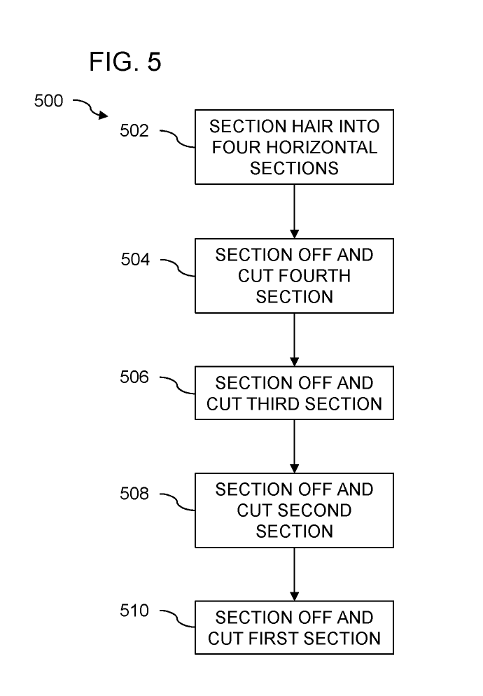

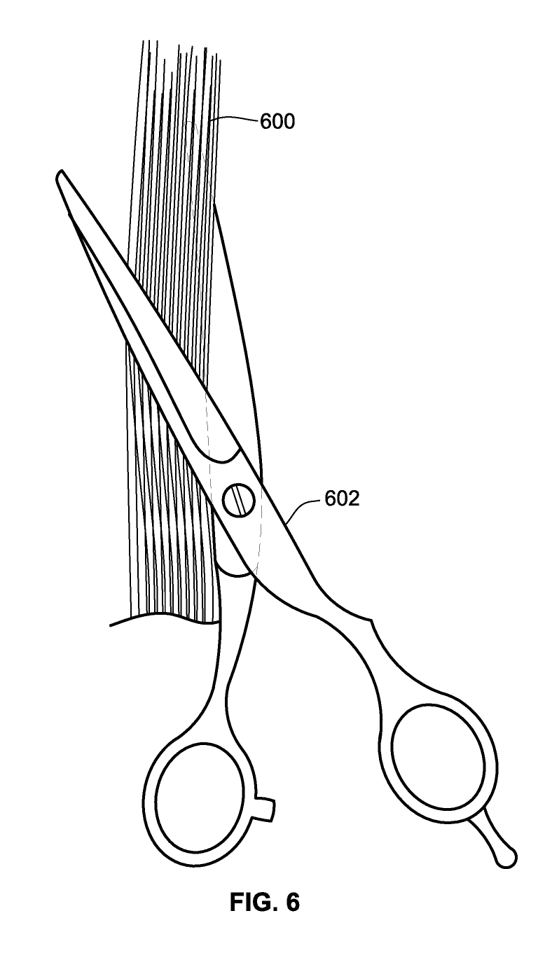

FIG. 5 shows a flow diagram of a method 500 of cutting hair, such as prior to styling the hair using a hair styling device (e.g., hair styling devices 100-400) as described herein, in accord with aspects of the present disclosure. Although specific steps of the method 500 are shown in a particular order, one or more of the steps may be omitted, or the order of the steps can be changed, without departing from the spirit and scope of the present disclosure. Though not specifically required to impart the wave as discussed above, the method 500 of cutting hair aids in the overall look of a naturally occurring wave in the hair.

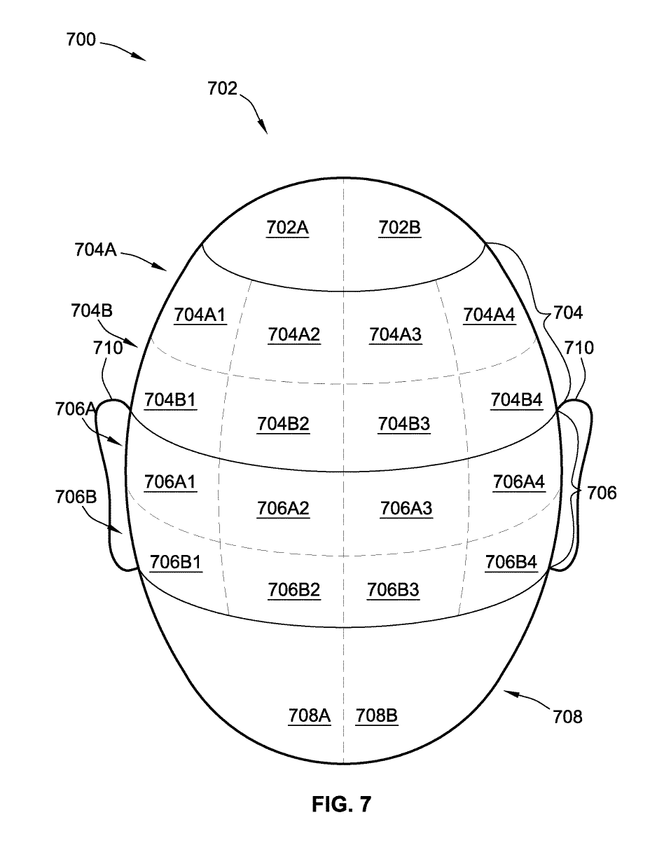

In the description of the flow diagram of FIG. 5, reference will be made to FIG. 6, which shows a section of hair 600 being trimmed with scissors 602, and FIG. 7, which shows a perspective view of a head 700 of hair (not shown for illustrative convenience) sectioned off as described below, in accord with aspects of the present disclosure.

At step 502, the hair is sectioned off into four horizontal sections 702, 704, 706, 708 (FIG. 7) that extend horizontally across the head. The first section 702 is at the crown of the head and forms a horse shoe part at the crown. The second section 704 corresponds to the bottom of the first section 702 and to the top of the ears 710 (FIG. 7) across the occipital bone. The third section 706 is from the top of the ears 710 to the bottom of the ears 710 across the occipital bone. The fourth section 708 is from the bottom of the ears 710 to the bottom of the hairline at the nape of the neck. After each section is sectioned off, the hair of each individual section is fastened together using a hair clip and held out of the way. For example, each section of fastened hair can be stacked on the previous section of fastened hair and clipped out of the way of working with the next section. Although four sections are described, alternatively the hair can be sectioned off into three sections, with the second and third sections being combined into one section.

At step 504, the fourth section 708 is the sectioned off horizontally into two subsections 708A and 708B that extend vertically up and down the head within the fourth section. One of the two subsections 708A, 708B is combed through with the hair extending approximately perpendicular to the skin surface at the root of the hair. The hair is then combed and twisted as it is lifted vertically up to be approximately straight up into the air. The section is twisted by twisting the entire length of the hair approximately 90 to 180 degrees in either a clockwise or counterclockwise direction. Referring to FIG. 6, with scissors 602 slightly off parallel to the subsection of hair 600, and with the subsection of hair 600 approximately straight up in the air, approximately one to three inches of the hair is removed by a slide cut to taper the subsection of hair 600. However, a greater or lesser length of hair can be removed with the cut depending on the desired length of the hair. The same procedure is performed on the remaining sub section.

At step 506, the third section 706 is sectioned off into top and bottom horizontal subsections 706A and 706B, and each of the top and bottom horizontal subsections 706A, 706B is further split into four additional subsections 706A1, 706A2, 706A3, 706A4 and 706B1, 706B2, 706B3, 706B4. The additional subsections include a far-left subsection 706A1, 706B1, a middle-left subsection 706A2, 706B2, a middle-right section 706A3, 706B3, and a far-right subsection 706A4, 706B4. However, based on the density of the hair, the number of additional subsections can be increased or decreased as required for managing the hair during the cutting process. An additional subsection is combed through with the hair extending approximately perpendicular to the skin surface at the root of the hair. The hair is then combed and twisted as it is lifted vertically up to be approximately straight up into the air. The additional subsection is twisted by twisting the entire length of the hair approximately 90 to 180 degrees in either a clockwise or counterclockwise direction. With scissors 602 slightly off parallel to the subsection of hair 600, and with the subsection of hair 600 approximately straight up in the air, approximately one to three inches of the hair is removed by a slide cut to taper the subsection of hair 600. However, a greater or lesser length of hair can be removed with the cut, depending on the desired length of the hair. The same procedure is performed on the remaining additional subsections. Although step 506 is described as sectioning off the third subsection 706 into subsections prior to combing and cutting the hair, the combing and cutting of the hair can be performed after each subsection if sectioned off

At step 508, the second section 704 is sectioned off into top and ottom horizontal subsections 704A and 704B, and each of the top and bottom horizontal subsections 704A, 704B is further split into four additional subsections 704A1, 704A2, 704A3, 704A4 and 704B1, 704B2, 704B3, 704B4. The additional subsections include a far-left subsection 704A1, 704B1, a middle-left subsection 704A2, 704B2, a middle-right section 704A3, 704B3, and a far-right subsection 704A4, 704B4. However, based on the density of the hair, the number of additional subsections can be increased or decreased as required for managing the hair during the cutting process. An additional subsection is combed through with the hair extending approximately perpendicular to the skin surface at the root of the hair. The hair is then combed and twisted as it is lifted vertically up to be approximately straight up into the air. The additional subsection is twisted by twisting the entire length of the hair approximately 90 to 180 degrees in either a clockwise or counterclockwise direction. With scissors 602 slightly off parallel to the subsection of hair 600, and with the subsection of hair 600 approximately straight up in the air, approximately one to three inches of the hair is removed by a slide cut to taper the subsection of hair 600. However, a greater or lesser length of hair can be removed with the cut, depending on the desired length of the hair. The same procedure is performed on the remaining additional subsections. Although step 508 is described as sectioning off the third subsection 704 into subsections prior to combing and cutting the hair, the combing and cutting of the hair can be performed after each subsection if sectioned off

At step 510, the first section 702 is allowed to fall to its natural shape after unfastening the hair and parting the hair into the desired or natural part, such as down the middle of the scalp. The hair is then sectioned into its natural sections or groupings of hair, such as sections 702A and 702B for a middle hair part. Each section is then combed and twisted as the hair is lifted vertically up to be approximately straight up into the air. The section is twisted by twisting the entire length of the hair approximately 90 to 180 degrees in either a clockwise or counterclockwise direction. With scissors 602 slightly off parallel to the subsection of hair 600, and with the subsection of hair 600 approximately straight up in the air, approximately one to three inches of the hair is removed by a slide cut to taper the subsection of hair. However, a greater or lesser length of hair can be removed with the cut, depending on the desired length of the hair. Each remaining section of the first section 702 is combed and cut according to the foregoing.

According to the method 500, the hair is cut by subsections, with the ends of each subsection being tapered, preferably significantly tapered. It is believed that tapering each subsection provides for a naturally looking wave when the hair is further stylized as described below and when using one of the hair styling devices 100-400 discussed above.

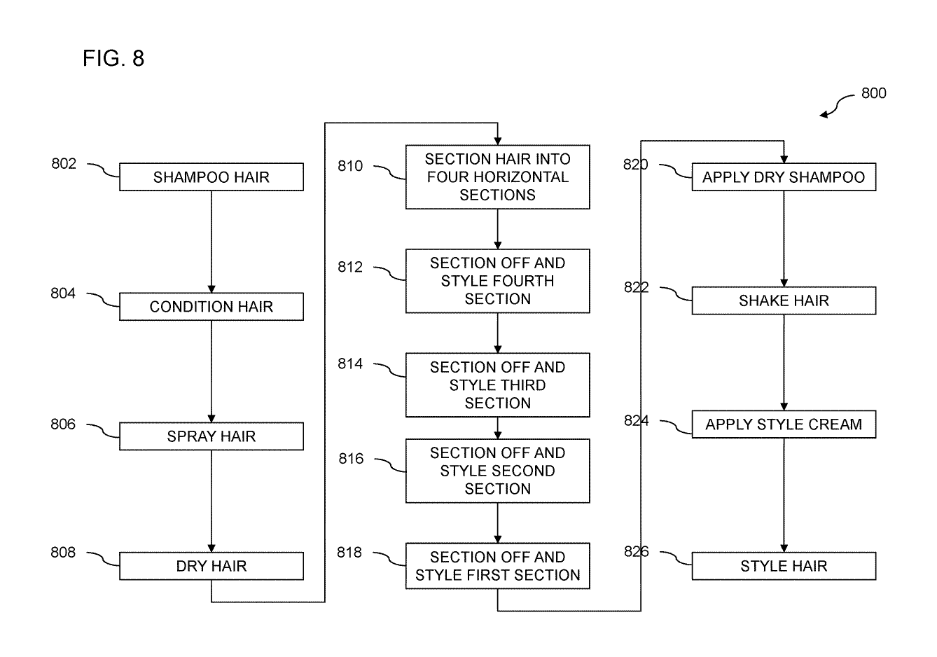

FIG. 8 shows a flow diagram of a method 800 of styling hair using a hair styling device (e.g., hair styling devices 100-400) as described herein, in accord with aspects of the present disclosure. Although specific steps of the method 800 are shown in a particular order, one or more of the steps may be omitted, or the order of the steps can be changed, without departing from the spirit and scope of the present concepts.

At step 802, the hair is shampooed. Any shampoo can be used. Preferably, a volumizing shampoo is used. The hair can be shampooed one or more times depending on how dirty the hair is. Preferably, the hair is shampooed twice to clean the hair and remove any product in the hair. Between each shampooing, the hair is rinsed of the shampoo lather. During shampooing, the focus of the shampooing is on the roots of the hair at the scalp, while also manipulating the lather through the hair to cover the middles and the ends of the hair. At the end step 802, the hair is rinsed of shampoo and excess water is removed. The excess water is removed by squeezing out the excess water down the length of the hair, which allows the hair to accept conditioner.

At step 804, the hair is conditioned. Any conditioner can be used. Preferably, the conditioner is a volumizing conditioner, and a dime or quarter size of conditioner is used. During conditioning, the focus of the conditioning is on the middles and ends of the hair. For example, the hair is placed in a ponytail and conditioned pony tail down towards the ends of the hair. At the end of step 804, using a wide tooth comb to aid in removing the conditioner by combing through the hair, the hair is rinsed of conditioner.

At step 806, a volumizing spray is applied to the roots of the hair, with the hair still damp from rinsing the conditioner. Further, a serum can be applied to the middles and ends of the hair.

At step 808, the process of drying the hair with a blow dryer begins. The blow drying starts by drying the roots starting at crown. Then, the hair is completely dried starting from the roots of the hair and working to the ends of the hair.

At step 810, the dry hair is sectioned off into four sections, similar to the method of cutting the hair described above. Namely, the hair is sectioned off into four horizontal sections. The first section is at the crown of the head and forms a horse shoe part at the crown. The second section corresponds to the bottom of the first section and to the top of the ears across the occipital bone. The third section is from the top of the ears to the bottom of the ears across the occipital bone. The fourth section is from the bottom of the ears to the bottom of the hairline at the nape of the neck. After each section is sectioned off, the hair is fastened together, out of the way. Although four sections are described, alternatively the hair can be sectioned off into three sections, with the second and third sections being combined into one section.

One of the hair styling devices 100-400 is used according to the steps discussed below to impart a naturally looking wave in a user's hair. Use of the hair styling devices 100-400 imparts the same oval-like cross-sectional profile in the user's hair as the oval-like cross-sectional profile of the heating portions 104-404. Use of the hair styling devices 100-400 varies slightly based on the capabilities of the devices 100-400.

For the hair styling device 100, each subsection of hair, discussed in greater detail below, is wrapped around the heating portion 104 starting at the roots and wrapping the subsection around the heating portion 104 up to the ends. Once wrapped around the heating portion 104, the hair is held against the heating portion 104 to impart the cross-sectional profile of the heating portion 104 into the hair. By way of example, and without limitation, the hair is held against the heating portion 104 for about 10 to 20 seconds, such as about 15 seconds.

For the hair styling device 200, the roots of the hair are placed between the tang 224 and the heating portion 204 to fill the gap 226. The hair is then drawn through the gap 226, from the roots of the hair to the ends of the hair, while rotating the heating portion 204.

For the hair styling device 300, the roots of the hair are placed between the tang 324 and the heating portion 304 to fill the gap 326. The hair is then drawn through the gap 326, from the roots of the hair to the ends of the hair. While drawing the hair through the gap 326, the user rotates his or her wrist in the desired direction of the rotation, while operating the motor by selecting the button 330. The direction of the wrist's rotation is detected by the sensor in the grip portion 302, and the motor accordingly rotates the heating portion 304 according to the same direction to rotate the hair as it passes between the heating portion 304 and the tang 324 through the hap 326. Alternatively, the user can control the direction of the motor based on the operation of the button 330, as discussed above. In some aspects, the button 330 operates as an automatic shutoff such that manipulating the button 330 causes the rotation of the heating portion 304 to stop. In some aspects, the automatic shutoff operation of the button 330 also cuts electricity to the heating element.

At step 812, starting at nape, the fourth section is horizontally sectioned off into two subsections. However, the number of subsections can be increased depending on the ability to style the amount of hair within each subsection. With any one of the hair styling devices 100-400, a wave is imparted into the hair as discussed above. The direction of the wave can be the same for each subsection or can be the opposite for adjacent subsections.

At step 814, the third section is sectioned off into a top and a bottom horizontal subsection, and each of the top and bottom horizontal subsections is further split into four additional subsections. The four additional subsections include a far-left subsection, a middle-left subsection, a middle-right section, and a far-right subsection. However, based on the density of the hair, the number of additional subsections can be increased or decreased as required for managing the hair during the styling process. The hair of each additional subsection is imparted with a wave in alternating, side-to-side directions, using any one of the hair styling devices 100-400 as discussed above.

At step 816, the second section is horizontally split into a top and a bottom horizontal subsection, and each of the top and bottom horizontal subsections is further split into four additional subsections. The four additional subsections include a far-left subsection, a middle-left subsection, a middle-right section, and a far-right subsection. However, based on the density of the hair, the number of additional subsections can be increased or decreased as required for managing the hair during the styling process. Starting from one side of the face, waves are imparted into the hair in alternating waves to the other side of the face using any one of the hair styling devices 100-400 as discussed above. The other subsections are then styled according to the same approach.

At step 818, the first section is sectioned off into three subsections, keeping in mind the desired part of the user. However, again, the number of subsections can be increased depending on the ability to style the amount of hair within each subsection. Beginning at one temple, waves are imparted into the hair as discussed above and are directed away from the face on both sides of head using any one of the hair styling devices 100-400 as discussed above.

At step 820, a dry shampoo is applied to the roots of the hair. Any dry shampoo can be used. Preferably the dry shampoo is a volumizing dry shampoo.

At step 822, the hair is flipped over the user's face. The waves of hair that are imparted into the hair from the proceeding steps are then shaken and allowed to fall/settle naturally.

At step 824, the hair is flipped back over and a styling cream is applied to the ends of hair.

At step 826, the hair is gently styled, such as by using one's fingers, to a desired position, and then lightly sprayed with hairspray to complete the process.

The result of the method 800, particularly in combination with the hair cut of the method 500 and when using one of the hair styling devices 100-400 is a naturally looking wave in the hair. In particular, a hair style is achieved that mimics the natural look of hair after a day at the beach.

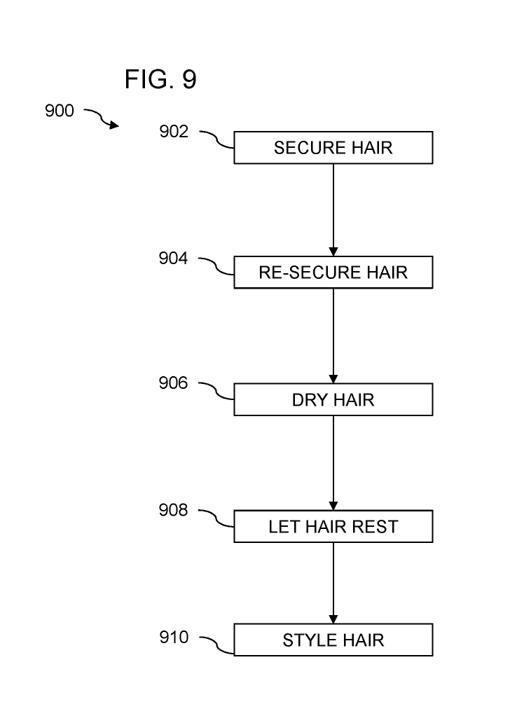

FIG. 9 shows a flow diagram of a method 900 of maintaining hair after styling the hair according to the method 800, and after using a hair styling devices 100-400 as described herein, in accord with aspects of the present disclosure. Although specific steps of the method 900 are shown in a particular order, one or more of the steps may be omitted, or the order of the steps can be changed, without departing from the spirit and scope of the present concepts.

To secure the hair, such as prior to sleep or before a shower, at step 902 the hair is gathered into a bun. The bun is loosely secured, such as with a hair tie, pin, clip, or the like.

At step 904, prior to showering, the hair is re-secured in the bun. Re-securing the hair may involve merely tightening the hair, such as re-tightening the hair tie. Alternatively, the hair may be re-secured by performing step 902. After securing the hair, the user may take a shower, focusing on preventing the hair from getting wet.

At step 906, once out of shower, the hair in the bun is heated using a blow dryer to remove any excess or built-up moisture. The hair at the hair line is then dried to remove any moisture that may have developed while drying the bun and/or accumulated during the shower.

At step 908, the hair is allowed to rest for approximately 15 to 30 minutes. After letting the hair rest, the hair is removed from the bun and shaken out vigorously.

At step 910, the hair is gently styled to the desired look. Then, the hair is sprayed with a light hair spray as desired for hold.

The method 900 allows one to maintain the achieved style from the method 500 and/or the method 800 over the course of several days. After several days, the hair may require performing at least the method 800 to achieve the natural wave look.

While the present disclosure has referenced one or more particular embodiments, those skilled in the art will recognize that many changes may be made thereto without departing from the spirit and scope of the present inventions. Each of these embodiments and obvious variations thereof is contemplated as falling within the spirit and scope of the inventions. It is also contemplated that additional embodiments according to aspects of the present inventions may combine any number of features from any of the embodiments described herein.

What is claimed is:

1. A hair styling device comprising:
a grip portion contoured for being gripped by a user, the grip portion including a power cable and a power switch at a first end for supplying and controlling electrical current to the hair styling device; and
a heating portion configured to generate heat based on the electrical current, the heating portion extending from the grip portion at a second end, opposite the first end, and having a cross-sectional profile with curved side portions between substantially circular ends along a length of the heating portion, the heating portion being configured to apply the heat to hair wrapped around the heating portion to impart a wave in the hair according to the cross-sectional profile.

2. The hair styling device of claim 1, further comprising:
a cable connector connecting the power cable to the first end of the grip portion, the cable connector allowing the power cable to rotate axially about the first end of the grip portion.

3. The hair styling device of claim 1, wherein the length of the heating portion is about 6 to 10 inches.

4. The hair styling device of claim 1, wherein a length of the long axis of the cross-sectional profile is about 1.25 to 1.75 inches.

5. The hair styling device of claim 4, wherein a length of the short axis of the cross-sectional profile is about 0.75 to 1 inch.

6. The hair styling device of claim 1, further comprising:
a tang assembly pivotally connected to the heating portion, the tang assembly including a handle and a tang, the handle extending down and being adjacent to the grip portion and the tang extending down and being adjacent to the heating portion.

7. The hair styling device of claim 6, wherein the hair styling device includes a gap between the heating portion and the tang with the tang assembly in a closed position.

8. The hair styling device of claim 7, wherein the gap is about 0.5 to 2 millimeters wide.

9. The hair styling device of claim 6, wherein a profile of the tang corresponds to the cross-sectional profile of the heating portion adjacent the tang.

10. The hair styling device of claim 1, wherein the grip portion includes a power level indicator.

11. The hair styling device of claim 1, wherein the heating portion is rotatable relative to the grip portion about a longitudinal axis of the hair styling device.

12. The hair styling device of claim 10, further comprising:
a motor that rotates the heating portion relative to the grip portion in a powered state.

13. The hair styling device of claim 11, further comprising:
a sensor that detects a rotational direction imparted on the grip portion by the user, wherein the motor rotates the heating portion based on the rotational direction in the powered state.

14. The hair styling device of claim 11, further comprising:
a switch that controls the powered state of the motor.

15. The hair styling device of claim 1, wherein the heating portion is removable from the grip portion.

16. The hair styling device of claim 1, wherein the heating portion is gold plated.

17. A method of styling hair on a head of an individual using the hair styling device of claim 1, the method comprising:
sectioning off the hair into at least three horizontal sections, the three horizontal sections including a first section forming a horse shoe part at the crown of the head, a second section ending at the ears across the occipital bone, and a third section ending at the nape;
sectioning off each of the at least three horizontal sections into subsections, each of the subsections being sized so as to be styled with the hair styling device;
wrapping each of the subsections around the heating portion; and
rotating the heating portion as each of the subsections is drawn across the heating portion to impart the cross-sectional profile of the heating portion in the subsections.

18. The method of claim 17, further comprising:
determining a direction of the rotation of the heating portion; and
energizing a motor to provide rotational assistance to the heating portion as the subsections are drawn across the heating portion to impart the cross-sectional profile of the heating portion in the subsections.

19. A method of cutting hair on a head of an individual, the method comprising:
sectioning off the hair into at least three horizontal sections, the three horizontal sections including a first section forming a horse shoe part at the crown of the head, a second section ending at the ears across the occipital bone, and a third section ending at the nape;
sectioning off each of the at least three horizontal sections into subsections, each of the subsections being sized so as to be cut with scissors with a single cut;
combing and twisting each of the subsections of the hair as each of the subsections of the hair is lifted vertically to be substantially straight up into the air; and
with the hair approximately straight up in the air, cutting the ends of the hair according to a taper cut.

20. The method of claim 19, wherein the hair is sectioned off into four sections, with the second section ending at the tops of the ears, and a fourth subsection between the second section and the fourth section.
